(19) United States
(12) Patent Application Publication
(10) Pub. No.: US 2008/0313029 A1
(43) Pub. Date: Dec. 18, 2008

(54) PUSH-CACHING SCHEME FOR A LATE-BINDING ADVERTISEMENT ARCHITECTURE

(75) Inventor: Gregory Morgan Evans, Raleigh, NC (US)

Correspondence Address: FlashPoint Technology and Withrow & Terranova, 100 Regency Forest Drive, Suite 160, Cary, NC, 27518, US

(73) Assignee: QURIO HOLDINGS, INC., Raleigh, NC (US)

(21) Appl. No.: 11/762,366

(22) Filed: Jun. 13, 2007

(51) Int. Cl. G06Q 30/00

(52) U.S. Cl. 705/14

(57) ABSTRACT

A system providing late-binding of advertisements to video content and incorporating a push-caching scheme is disclosed. In general, the system includes an advertisement server located at a central location such as a central headend and a number of late-binding systems located at locations such as a number of remote headends. The late-binding systems are connected to the advertisement server via a Wide Area Network (WAN). Each of the late-binding systems is also connected to an associated advertisement cache via a Local Area Network (LAN). A cache assignment agent associated with the advertisement server operates to push advertisements to the advertisement caches associated with the late-binding systems in a predictive fashion based on, for example, historical information for the late-binding systems and/or profiles of users or viewers associated with the client devices served by the late-binding systems.

### FIELD OF THE INVENTION

The present invention relates to late-binding of advertisements to video content and more specifically relates to a push-caching scheme for a late-binding advertisement architecture.

### BACKGROUND OF THE INVENTION

Targeted or narrowcast advertising provides an effective model for merchants to reach consumers. For example, a business selling children's apparel can benefit from narrowcast ad distribution by limiting its advertising to parents. As another example, advertisements may be matched with content being viewed and preferences of the viewer in order to provide a personalized viewing experience. Additionally, late-binding of advertisements may be combined with narrowcasting to provide even greater value to the consumer and merchant. With late-binding, advertisements are matched to and inserted into content during playback. As such, the times at which advertisements are presented and the number of times that an advertisement is presented can easily be controlled.

One issue with narrowcasting and late-binding of advertisements is that current digital cable television, satellite television, and Internet Protocol Television (IPTV) architectures do not efficiently scale to accommodate late-binding of narrowcast advertisements as the narrowcasting becomes more targeted and the number of users grows. As such, there is a need for a system and method providing efficient late-binding of narrowcast advertisements in digital cable television, satellite television, and IPTV architectures, or the like.

### SUMMARY OF THE INVENTION

The present invention relates to a system providing late-binding of advertisements to video content and incorporating a push-caching scheme. In general, the system includes an advertisement (ad) content server located at a central location such as a central headend and a number of late-binding systems located at remote locations such as a number of remote headends. The late-binding systems are connected to the advertisement server via a Wide Area Network (WAN). Each of the late-binding systems is also connected to an associated advertisement cache. A cache assignment agent associated with the advertisement server operates to push advertisements to the advertisement caches associated with the late-binding systems in a predictive fashion based on, for example, historical information for the late-binding systems and/or profiles of users or viewers associated with client devices served by the late-binding systems.

More specifically, in one embodiment, the ad content server operates to store an advertisement for each of a number of advertisement categories in a high-speed storage device. For each client device served by a late-binding system, the late-binding system operates to detect an advertisement slot in video content delivered to the client device and select one of the advertisement categories for the ad slot based on criteria such as metadata describing the video content and/or a profile of a user or viewer associated with the client device. Assuming that the advertisement for the selected advertisement category is not cached, the late-binding system initiates a Remote Direct Memory Access (RDMA) transfer of the advertisement for the selected advertisement category from the high-speed storage device of the ad content server to an ad buffer of the late-binding system. The advertisement is then inserted into the detected ad slot as the video content is delivered to the client device.

According to the present invention, the late-binding systems further operate to provide signatures to the cache assignment agent. The signatures include information such as, for example, historical information describing advertisements or categories of advertisements previously selected for insertion at the late-binding systems, advertisements or categories of advertisements expected to be needed by the late-binding systems in the future, profiles of users or viewers associated with the client devices served by the late-binding systems, or the like. Based on the signatures, the cache assignment agent identifies advertisement categories that are or expected to be most used by each of the late-binding systems. The advertisements for the advertisement categories identified for each late-binding system are then pushed to the associated advertisement caches utilizing RDMA transfers. Thereafter, when one of the late-binding systems desires an advertisement from an advertisement category stored in its advertisement cache, the late-binding system obtains the advertisement from the advertisement cache rather than the high-speed storage of the advertisement server. As a result, efficiency is improved and the load on the WAN connecting the late-binding systems and the advertisement server is substantially reduced.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system providing late-binding of advertisements to video content and incorporating a push-caching scheme according to one embodiment of the present invention;

FIG. 2 is a more detailed illustration of an exemplary embodiment of one of the late-binding systems of FIG. 1;

FIG. 3 is a flow chart illustrating the operation of one of the local agents of FIG. 1 according to one embodiment of the present invention; and

FIG. 4 is a flow chart illustrating the operation of the cache assignment agent of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

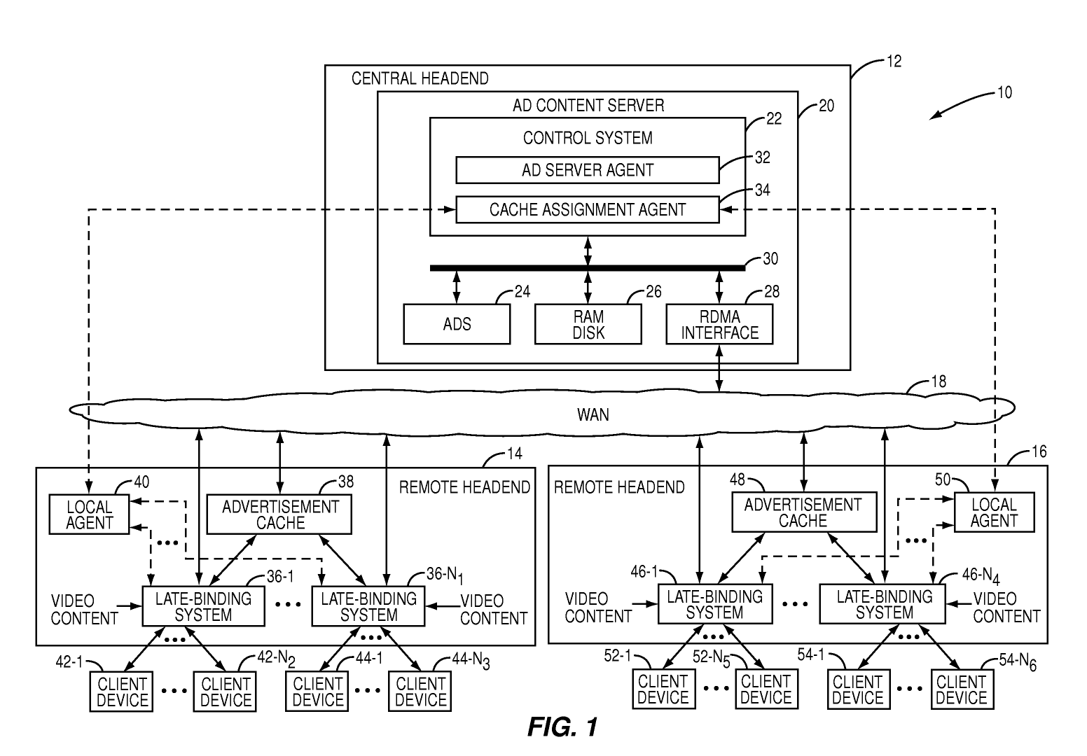

FIG. 1 illustrates a system 10 according to one embodiment of the present invention. In general, the system 10 includes a central headend 12 connected to remote headends 14 and 16 via a Wide Area Network (WAN) 18. The central headend 12 includes an advertisement (ad) content server 20. In this embodiment, the ad content server 20 includes a control system 22 connected to an advertisement database 24, a Random Access Memory (RAM) disk 26, and a Remote Direct Memory Access (RDMA) interface 28 via a bus 30. The control system 22 includes an ad server agent 32 and a cache assignment agent 34. The ad server agent 32 and the cache assignment agent 34 may each be implemented in software, hardware, or a combination thereof. The advertisement database 24 operates to store a number of advertisements and optionally metadata describing the advertisements, information identifying target viewers of the advertisements, and the like. Under the control of the ad server agent 32, a range of addresses or sections of the RAM disk 26 is allocated to each of a number of advertisement categories. An advertisement for each advertisement category is stored in the corresponding range of addresses of the RAM disk 26. The advertisements may be replaced in the RAM disk 26 as needed or desired. Note that the RAM disk 26 is exemplary. Any type of storage device having a sufficiently fast access time may be used. The RDMA interface 28 enables RDMA transfers of advertisements from the RAM disk 26 to the remote headends 14 and 16. In one embodiment, iWARP, RDMA over Ethernet (RoE), or similar technology may be used to carry RDMA traffic over the WAN 18. Note that while iWARP and RoE are sometimes used interchangeably, as used herein, RoE refers to technology for transferring RDMA traffic over Ethernet without requiring the Transmission Control Protocol (TCP) or Internet Protocol (IP) layer.

For more information regarding the operation of the ad content server 20 with respect to the ad server agent 32, the advertisement database 24, the RAM disk 26, and the RDMA interface 28, the interested reader is directed to U.S. patent application Ser. No. 11/685,479, entitled LATE-BINDING OF ADVERTISEMENTS USING RDMA CONNECTIVITY, which was filed on Mar. 13, 2007 and is hereby incorporated by reference in its entirety.

The remote headend 14 includes a number of late-binding systems 36-1 through 36-N₁, an advertisement cache 38, and a local agent 40. Note that the remote headend 14 may include any number of one or more late-binding systems. Further, while the local agent 40 is illustrated as a separate component, the local agent 40 may be implemented on a stand-alone server, as part of one of the late-binding systems 36-1 through 36-N₁, or distributed among two or more of the late-binding systems 36-1 through 36-N₁. Preferably, the late-binding systems 36-1 through 36-N₁, the advertisement cache 38, and the local agent 40 are connected by a Local Area Network (LAN). Also, while not illustrated, the advertisement cache 38 either includes or is hosted by a system or device including an RDMA interface.

The late-binding systems 36-1 through 36-N₁ may be implemented in hardware, software, or a combination thereof and generally operate to perform late-binding of advertisements to video content. More specifically, the late-binding system 36-1 serves a number of client devices 42-1 through 42-N₂. In one embodiment, the late-binding system 36-1 provides a separate streaming channel to each of the client devices 42-1 through 42-N₂. The streaming channels may be, for example, Switched Digital Video (SDV) channels, Internet Protocol Television (IPTV) channels, or the like. Likewise, the late-binding system 36-N₁ serves a number of client devices 44-1 through 44-N₃.

In a similar fashion, the remote headend 16 includes a number of late-binding systems 46-1 through 46-N₄, an advertisement cache 48, and a local agent 50. Note that the remote headend 16 may include any number of one or more late-binding systems. Further, while the local agent 50 is illustrated as a separate component, the local agent 50 may be implemented on a stand-alone server, as part of one of the late-binding systems 46-1 through 46-N₄, or distributed among two or more of the late-binding systems 46-1 through 46-N₄. Preferably, the late-binding systems 46-1 through 46-N₄, the advertisement cache 48, and the local agent 50 are connected by a LAN. Also, while not illustrated, the advertisement cache 48 either includes or is hosted by a system or device including an RDMA interface.

The late-binding systems 46-1 through 46-N₄ may be implemented in hardware, software, or a combination thereof and generally operate to perform late-binding of advertisements to video content. More specifically, the late-binding system 46-1 serves a number of client devices 52-1 through 52-N₅. In one embodiment, the late-binding system 46-1 provides a separate streaming channel to each of the client devices 52-1 through 52-N₅. The streaming channels may be, for example, SDV channels, IPTV channels, or the like. Likewise, the late-binding system 46-N₄ serves a number of client devices 54-1 through 54-N₆.

In operation, the local agents 40 and 50 obtain information from the late-binding systems 36-1 through 36-N₁ and 46-1 through 46-N₄ such as, for example, information identifying advertisements or advertisement categories selected for late-binding; information identifying advertisements or advertisement categories watched or skipped by users or viewers at the client devices 42-1 through 42-N₂, 44-1 through 44-N₃, 52-1 through 52-N₅, and 54-1 through 54-N₆; information identifying video content currently being provided to the client devices 42-1 through 42-N₂, 44-1 through 44-N₃, 52-1 through 52-N₅, and 54-1 through 54-N₆; or the like. The local agents 40 and 50 aggregate the information and optionally historical information and profiles of the users or viewers associated with the client devices 42-1 through 42-N₂, 44-1 through 44-N₃, 52-1 through 52-N₅, and 54-1 through 54-N₆ to provide signatures for the remote headends 14 and 16, respectively. The profiles of the users or viewers may include, for example, demographic information describing the users or viewers, biographical information describing the users or viewers, preferences of the users or viewers, or the like. The signatures may also be referred to herein as cluster signatures, where the cluster signature from the local agent 40 is indicative of advertisement categories historically used by or expected to be used by the late-binding systems 36-1 through 36-N₁ and the cluster signature from the local agent 50 is indicative of advertisement categories historically used by or expected to be used by the late-binding systems 46-1 through 46-N₄.

The signatures include information such as, for example, information identifying advertisement categories previously selected by the late-binding systems 36-1 through 36-N₁ and 46-1 through 46-N₄; information identifying advertisement categories expected to be selected by the late-binding systems 36-1 through 36-N₁ and 46-1 through 46-N₄ in the future based on, for example, the video content currently being provided to the client devices 42-1 through 42-N₂, 44-1 through 44-N₃, 52-1 through 52-N₅, and 54-1 through 54-N₆ or recent browsing of programming by the users or viewers at the client devices 42-1 through 42-N₂, 44-1 through 44-N₃, 52-1 through 52-N₅, and 54-1 through 54-N₆; profiles of the users associated with or viewers at the client devices 42-1 through 42-N₂, 44-1 through 44-N₃, 52-1 through 52-N₅, and 54-1 through 54-N₆; information derived from the profiles of the users or viewers; average usage by the users or viewers at the client devices 42-1 through 42-N₂, 44-1 through 44-N₃, 52-1 through 52-N₅, and 54-1 through 54-N₆; or the like.

The cache assignment agent 34 receives the signatures from the local agents 40 and 50. Based on the signatures, the cache assignment agent 34 determines whether advertisements for any of the advertisement categories should be pushed from the RAM disk 26 of the ad content server 20 to the advertisement caches 38 and 48 at the remote headends 14 and 16, respectively. Any algorithm for identifying which advertisement categories are to be pushed to the advertisement caches 38 and 48 may be used. For example, if an advertisement category is expected to be selected by more than one of the late-binding systems 36-1 through 36-N₁ over a defined period of time such as an hour or a day, the cache assignment agent 34 may identify the advertisement category as one for which advertisements are to be pushed to the advertisement cache 38. As another example, if an advertisement category has historically been used frequently by the late-binding systems 36-1 through 36-N₁, then the cache assignment agent 34 may identify the advertisement category as one for which advertisements are to be pushed to the advertisement cache 38.

Once the advertisement categories to be cached at the advertisement cache 38 are identified, the cache assignment agent 34 initiates RDMA transfers of the advertisements for the identified advertisement categories from the RAM disk 26 to the advertisement cache 38. Likewise, once the advertisement categories to be cached at the advertisement cache 48 are identified, the cache assignment agent 34 initiates RDMA transfers of the advertisements for the identified advertisement categories from the RAM disk 26 to the advertisement cache 48. When new advertisements for the identified advertisement categories are rotated into the RAM disk 26, the new advertisements are pushed to the advertisement caches 38 and 48.

Thereafter, the late-binding systems 36-1 through 36-N₁ and 46-1 through 46-N₄ obtain advertisements from the identified categories from the advertisement caches 38 and 48, respectively, rather than the ad content server 20. More specifically, using the client device 42-1 as an example, the late-binding system 36-1 streams video content to the client device 42-1. When an upcoming ad slot is detected, the late-binding system 36-1 selects one of the number of advertisement categories hosted by the ad content server 20, obtains the advertisement for the selected advertisement category from either the advertisement cache 38 or the RAM disk 26 of the ad content server 20 depending on whether the selected advertisement category has been assigned to the advertisement cache 38, and inserts the advertisement into the detected ad slot as the video content is streamed to the client device 42-1.

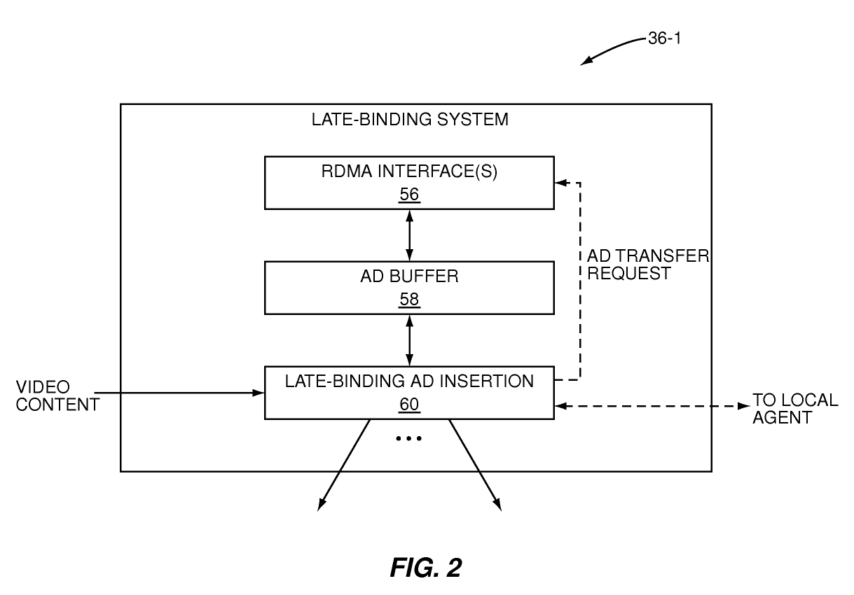

FIG. 2 illustrates an exemplary embodiment of the late-binding system 36-1. This discussion is equally applicable to the other late-binding systems 36-2 through 36-N₁ and 46-1 through 46-N₄. The late-binding system 36-1 may be implemented in hardware, software, or a combination thereof. In general, the late-binding system 36-1 includes one or more RDMA interfaces 56, an ad buffer 58, and a late-binding ad insertion function 60. The one or more RDMA interfaces 56 enable RDMA transfers of advertisements from the RAM disk 26 of the ad content server 20 to the ad buffer 58 or from the advertisement cache 38 to the ad buffer 58 under the control of the late-binding ad insertion function 60. More specifically, in one embodiment, the one or more RDMA interfaces 56 include a first RDMA interface utilizing Infiniband, RDMA over Ethernet (RoE), or similar technology to perform RDMA transfers from the advertisement cache 38 to the ad buffer 58 and a second RDMA interface utilizing RoE, iWARP, or similar technology to perform RDMA transfers from the RAM disk 26 of the ad content server 20 to the ad buffer 58.

The late-binding ad insertion function 60 obtains a mapping of advertisement categories and RDMA address ranges from the ad content server 20. In one embodiment, the mapping includes metadata describing the advertisement categories, information identifying the range of addresses in the RAM disk 26 allocated for each advertisement category, and information identifying the range of addresses in the advertisement caches 38 and 48 for advertisement categories assigned to the advertisement caches 38 and 48.

In operation, the late-binding ad insertion function 60 inserts advertisements into advertisement slots in video content as the video content is streamed to the client devices 42-1 through 42-N₂. The video content may be movies, television programs, or the like provided in a Video on Demand (VoD) fashion or broadcast television content. More specifically, under the direct or indirect control of the client device 42-1, for example, the late-binding ad insertion function 60 obtains video content selected by the user or viewer at the client device 42-1 and begins streaming the video content to the client device 42-1. Upon detecting an upcoming ad slot in the video content, the late-binding ad insertion function 60 selects one of the advertisement categories for the ad slot. The late-binding ad insertion function 60 may select the advertisement category based on a comparison of the metadata describing the advertisement categories from the mapping and metadata describing the video content, information identifying advertisements or advertisement categories previously watched or skipped by the user or viewer associated with the client device 42-1, demographic information describing the user or viewer associated with the client device 42-1, biographical information describing the user or viewer associated with the client device 42-1, preferences of the user or viewer associated with the client device 42-1, or the like.

After selecting the advertisement category, the late-binding ad insertion function 60 obtains the advertisement for the selected advertisement category from either the advertisement cache 38 or the RAM disk 26 of the ad content server 20 depending on whether advertisements for the selected advertisement category are assigned to the advertisement cache 38. More specifically, in one embodiment, if the entry in the mapping for the selected advertisement category includes an address range for the advertisement category in the advertisement cache 38, then the late-binding ad insertion function 60 initiates an RDMA transfer of the advertisement for the selected advertisement category from the advertisement cache 38 to the ad buffer 58. Otherwise, the late-binding ad insertion function 60 initiates an RDMA transfer of the advertisement for the selected advertisement category from the RAM disk 26 of the ad content server 20 to the ad buffer 58 using the address range for the selected advertisement category in the RAM disk 26 from the mapping. Thereafter, the late-binding ad insertion function 60 inserts the advertisement from the ad buffer 58 into the ad slot in the video content as the video content is streamed to the client device 42-1.

For more information regarding an exemplary embodiment of the late-binding system 36-1, the interested reader is directed to U.S. patent application Ser. No. 11/760,013, entitled MULTI-CLIENT STREAMER WITH LATE BINDING OF AD CONTENT, which was filed on Jun. 8, 2007 and is hereby incorporated herein by reference in its entirety.

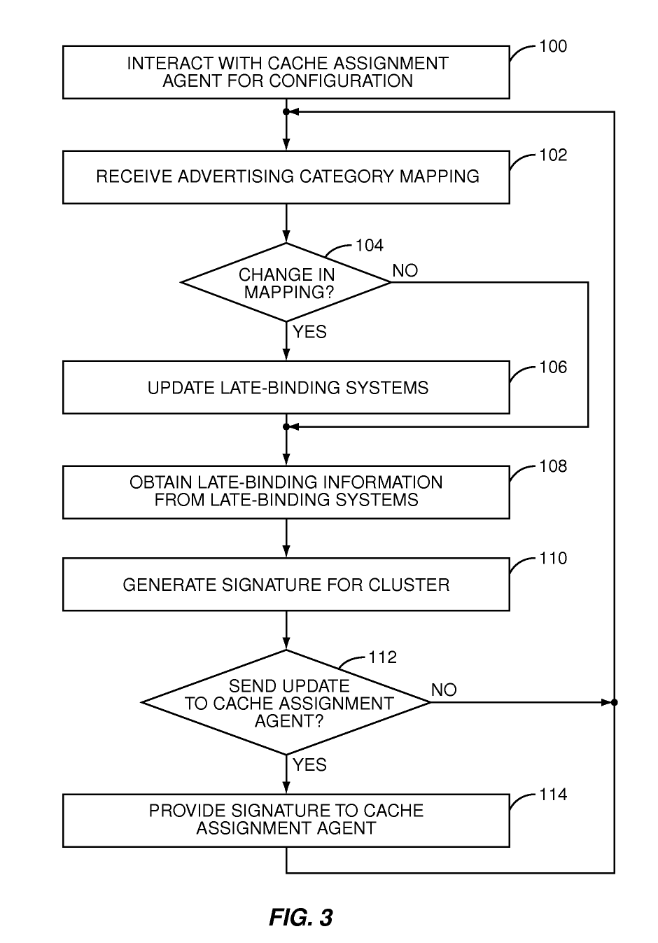

FIG. 3 illustrates the operation of the local agent 40 according to one embodiment of the present invention. This discussion is equally applicable to the local agent 50. First, the local agent 40 interacts with the cache assignment agent 34 for configuration (step 100). During configuration, the cache assignment agent 34 may configure the local agent 40 such that the signature for the late-binding systems 36-1 through 36-N₁ generated by the local agent 40 includes desired information. For example, the cache assignment agent 34 may define metadata categories to be included in the signature, a historical time interval for the signature defining a time period relative to the current time for which historical information is to be considered and included in the signature, a future time interval for the signature defining a period of time relative to the current time for which predictions as to advertisement categories expected to be used in the future are to be made and included in the signature, and a template or algorithm to be used to generate the signature and/or to be used to generate predictions for the future interval.

Once configuration is complete, the local agent 40 receives an advertisement category mapping from either the ad server agent 32 or the cache assignment agent 34 (step 102). In one embodiment, the local agent 40 obtains the mapping from a multicast communication channel over which the ad content server 20 continuously or periodically multicasts the mapping. As discussed above, the advertisement category mapping includes metadata or information describing the advertisement categories and a range of addresses allocated for each of the advertisement categories in the RAM disk 26 of the ad content server 20. In addition, once advertisements are pushed to the advertisement caches 38 and 48, the mapping may also include a range of addresses in the advertisement cache 38 allocated to each advertisement category assigned to the advertisement cache 38 and a range of addresses in the advertisement cache 48 allocated to each advertisement category assigned to the advertisement cache 48. Note that the address ranges in the advertisement caches 38 and 48 allocated to advertisement categories assigned to the advertisement caches 38 and 48 may be provided to or determined by the local agents 40 and 50 in any manner. Including these address ranges in the advertisement category mapping is exemplary and not intended to limit the scope of the present invention.

After receiving the mapping, the local agent 40 determines whether the mapping has changed since the last time it was received (step 104). Note that, in this embodiment, the mapping is continuously multicast or periodically multicast to the local agents 40 and 50. If the mapping has not changed, the process proceeds to step 108. If the mapping has changed, the local agent 40 updates the late-binding systems 36-1 through 36-N₁ (step 106). More specifically, the local agent 40 may provide the new mapping or an update to the mapping to the late-binding systems 36-1 through 36-N₁.

The local agent 40 then obtains late-binding information from the late-binding systems 36-1 through 36-N₁ (step 108). In one embodiment, the local agent 40 requests the information from the late-binding systems 36-1 through 36-N₁. In another embodiment, the late-binding systems 36-1 through 36-N₁ automatically provide the information to the local agent 40. The information may include, for example, information identifying advertisements or advertisement categories selected for use by the late-binding systems 36-1 through 36-N₁, information identifying advertisements or advertisement categories watched or skipped by the users or viewers at the client devices 42-1 through 42-N₂ and 44-1 through 44-N₃, or the like. In addition, the local agent 40 may obtain profiles of the users or viewers of the client devices 42-1 through 42-N₂ and 44-1 through 44-N₃ either from the late-binding systems 36-1 through 36-N₁ or some other system such as a local or remote database.

Based on this information, the local agent 40 generates a signature for the late-binding systems 36-1 through 36-N₁ (step 110). In one embodiment, the local agent 40 generates the signature based on rules and/or templates received from the cache assignment agent 34 during configuration. In general, the signature includes information enabling the cache assignment agent 34 to assign advertisement categories to the advertisement cache 38 that are likely to be selected by one or more of the late-binding systems 36-1 through 36-N₁ in the future or to be in high demand by the late-binding systems 36-1 through 36-N₁. In one embodiment, the signature may include information identifying the number of advertisements or percentage of overall advertisements used for late-binding for each of a number of the advertisement categories, a subset of the advertisement categories, or groups of the advertisement categories over a defined historical period. In addition or alternatively, the signature may include information identifying one or more of the advertisement categories expected to be used for late-binding during a defined period of time in the future and optionally a number of advertisements or percentage of overall advertisements expected for each of those advertisement categories. The signature may also include an average number of active channels for the late-binding systems 36-1 through 36-N₁.

In this embodiment, once the signature is generated, the local agent 40 determines whether to send the signature, or update to the signature, to the cache assignment agent 34 (step 112). More specifically, if the local agent 40 has provided a signature to the cache assignment agent 34 in the past, the local agent 40 determines whether the signature has changed before sending the signature to the cache assignment agent 34. In one embodiment, a threshold amount of change or delta may be defined. If the signature or update to the signature is not to be sent, the process returns to step 102 and is repeated. Otherwise, the local agent 40 provides the signature or an update to the signature to the cache assignment agent 34 (step 114). The process then returns to step 102 and is repeated.

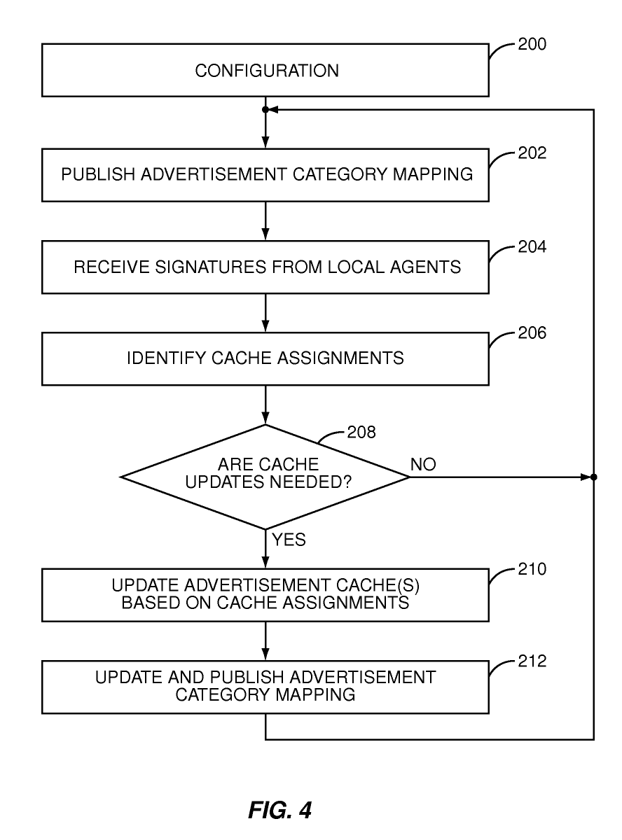

FIG. 4 illustrates the operation of the cache assignment agent 34 according to one embodiment of the present invention. First, the cache assignment agent 34 performs a configuration process (step 200). For example, the during configuration, the cache assignment agent 34 may determine the topology of the system such as available bandwidth on the LANs of the remote headends 14 and 16 for RDMA advertisement transfers, available bandwidth on the WAN 18 for RDMA advertisement transfers, average latency on LAN connections, and average latency on WAN connections; locations of the advertisement caches 38 and 48; potential number of streaming output channels for each remote headend 14 and 16; maximum number of advertisement categories that may be cached by the advertisement caches 38 and 48; current advertisement category assignments for the advertisement caches 38 and 48; and rules or templates for caching such as rules or templates optimized for WAN usage, rules or templates optimized for ad transfer latency, or rules or templates optimized for certain metadata categories.

Next, the cache assignment agent 34 publishes the advertisement category mapping to the local agents 40 and 50 (step 202). Note that the advertisement category mapping may alternatively be published by the ad server agent 32 where the cache assignment agent 34 interacts with the ad server agent 32 to update the mapping to reflect cache assignments. The cache assignment agent 34 also receives the signatures from the local agents 40 and 50 (step 204). The cache assignment agent 34 may poll the local agents 40 and 50. Alternatively, the local agents 40 and 50 may provide the signatures to the cache assignment agent 34 automatically.

Based on the signatures from the local agents 40 and 50, the cache assignment agent 34 identifies cache assignments for the advertisement caches 40 and 50 (step 206). In general, the cache assignment agent 34 identifies advertisement categories likely to be selected by the late-binding systems 36-1 through 36-N₁ in the future based on the signature from the local agent 40 and assigns the identified advertisement categories to the advertisement cache 38. Likewise, the cache assignment agent 34 identifies advertisement categories likely to be selected by the late-binding systems 46-1 through 46-N₄ in the future based on the signature from the local agent 50 and assigns the identified advertisement categories to the advertisement cache 48.

In this embodiment, the cache assignment agent 34 then determines whether updates to the advertisement caches 38 and 48 are needed (step 208). Updates are needed when, for example, the advertisement categories assigned to the advertisement caches 38 and 48 change. Updates are also needed when the advertisement for one or more of the advertisement categories assigned to the advertisement caches 38 and 48 changes. If the advertisement caches 38 and 48 do not need to be updated, the process returns to step 202 or alternatively step 204 and is repeated. If one or more of the advertisement caches 38 and 48 needs to be updated, the cache assignment agent 34 updates the advertisement caches 38 and 48 based on the cache assignments (step 210). More specifically, the cache assignment agent 34 initiates RDMA transfers of the advertisement for each of the advertisement categories assigned to the advertisement cache 38 or each of the advertisement categories to be updated from the RAM disk 26 of the ad content server 20 to the advertisement cache 38. Likewise, the cache assignment agent 34 initiates RDMA transfers of the advertisement for each of the advertisement categories assigned to the advertisement cache 48 or each of the advertisement categories to be updated from the RAM disk 26 of the ad content server 20 to the advertisement cache 48.

In addition, the cache assignment agent 34 updates the advertisement category mapping, which is then published by either the cache assignment agent 34 or the ad server agent 32 (step 212). In one embodiment, the cache assignment agent 34 updates the mapping to reflect the advertisement categories assigned to the advertisement caches 38 and 48 and the range of addresses in the advertisement caches 38 and 48 allocated to those advertisement categories. The process then returns to step 202 or alternatively step 204 and is repeated.

It should be noted that steps 208-212 may alternatively be performed only when the advertisement categories assigned to one of the advertisement caches 38 and 48 change. In this case, a separate process handles the situation where new advertisements are rotated into the RAM disk 26. When this occurs, new advertisements for advertisement categories assigned to the advertisement cache 38 are pushed to the corresponding range of addresses allocated to the advertisement categories in the advertisement cache 38. As a result, the new advertisements replace the previous advertisements for the advertisement categories stored in the advertisement cache 38. The advertisement cache 48 is updated in a similar fashion.

The present invention provides substantial opportunity for variation. For example, while the system 10 discussed herein includes only a single ad content server 20, the present invention is not limited thereto. More specifically, the system 10 may include multiple ad content servers 20 which may or may not be located at the same central headend 12. In one embodiment, each of the ad content servers 20 may include its own cache assignment agent and the remote headends 14 and 16 may either include a separate advertisement cache for each ad content server 20, partition the advertisement caches 38 and 48 for the different ad content servers 20, or allocate sections of the advertisement caches 38 and 48 to the ad content servers 20. In another embodiment, the cache assignment agents of the ad content servers 20 may collaborate such that they do not overwrite each other's advertisements in the advertisement caches 38 and 48. As another alternative, a central cache assignment agent may perform cache assignment for each of the ad content servers 20. The central cache assignment agent may be hosted by a separate server, hosted by one of the ad content servers 20, or distributed among two or more of the ad content servers 20.

As a second example, while a single local agent 40, 50 is described above for each remote headend 14, 16, the present invention is not limited thereto. For example, each of the late-binding systems 36-1 through 36-N₁ may have its own local agent. The remote headend 14 may then include a separate advertisement cache 38 for each of the late-binding systems 36-1 through 36-N₁, partition the advertisement cache 38 for the late-binding systems 36-1 through 36-N₁, or allocate sections of the advertisement cache 38 for each of the late-binding systems 36-1 through 36-N₁.

As a third example, while the late-binding systems 36-1 through 36-N₁ and 46-1 through 46-N₄ are described above as obtaining advertisements from either the ad content server 20 or their respective advertisement caches 38 and 48, the present invention is not limited thereto. More specifically, since the advertisement category mapping may include the address ranges of each advertisement category in the RAM disk 26 as well as the address ranges for any cached advertisement categories in the advertisement caches 38 and 48, the late-binding systems 36-1 through 36-N₁ may obtain advertisements from the advertisement cache 48 at the remote headend 16 if needed or desired. Likewise, the late-binding systems 46-1 through 46-N₄ may obtain advertisements from the advertisement cache 38 at the remote headend 14 if needed or desired.

As a final example, while the discussion above focuses on a LAN connection between the advertisement caches 38 and 48 and the respective late-binding systems 36-1 through 36-N₁ and 46-1 through 46-N₄, the present invention is not limited thereto. More specifically, direct connections may alternatively be used.

Those skilled in the art will recognize improvements and modifications to the preferred embodiments of the present invention. All such improvements and modifications are considered within the scope of the concepts disclosed herein and the claims that follow.

What is claimed is:

1. A system comprising:
a) an ad content server storing an advertisement for each of a plurality of advertisement categories;
b) an advertisement cache communicatively coupled to the ad content server via a network, the advertisement cache associated with at least one late-binding system adapted to perform late-binding of advertisements to video content; and
c) a cache assignment agent associated with the ad content server and adapted to:
i) assign at least one of the plurality of advertisement categories to the advertisement cache; and
ii) effect transfer of the advertisement for the at least one of the plurality of advertisement categories from the ad content server to the advertisement cache, wherein the at least one late-binding system subsequently obtains the advertisement from the advertisement cache for use in a late-binding operation.

2. The system of claim 1 wherein the ad content server comprises:
a high-speed storage device adapted to store the advertisement for each of the plurality of advertisement categories; and
a Remote Direct Memory Access (RDMA) interface associated with the high-speed storage device;
wherein in order to effect transfer of the advertisement for the at least one of the plurality of advertisement categories from the ad content server to the advertisement cache, the cache assignment agent is further adapted to initiate an RDMA transfer of the advertisement for the at least one of the plurality of advertisement categories from the high-speed storage device to the advertisement cache via the RDMA interface.

3. The system of claim 1 wherein the cache assignment agent is further adapted to assign the at least one of the plurality of advertisement categories to the advertisement cache based on at least one of a group consisting of: historical use and expected use.

4. The system of claim 1 wherein the cache assignment agent is hosted by the ad content server.

5. The system of claim 1 further comprising:
the at least one late-binding system; and
a local agent associated with the at least one late-binding system adapted to:
generate a signature for the at least one late-binding system; and
provide the signature to the cache assignment agent;
wherein the cache assignment agent is further adapted to assign the at least one of the plurality of advertisement categories to the advertisement cache based on the signature.

6. The system of claim 5 wherein the signature includes information indicative of at least one of a group consisting of: at least one of the plurality of advertisement categories previously used by the at least one late-binding system for a late-binding operation, at least one of the plurality of advertisement categories expected to be used by the at least one late-binding system, at least one advertisement previously skipped by a viewer at a client device served by the at least one late-binding system, at least one of the plurality of advertisement categories for which an advertisement was previously skipped by a viewer of a client device served by the at least one late-binding system, at least one advertisement previously viewed by a viewer at a client device served by the at least one late-binding system, at least one of the plurality of advertisement categories for which an advertisement was previously viewed by a viewer at a client device served by the at least one late-binding system, and profiles of viewers associated with client devices served by the at least one late-binding system.

7. The system of claim 1 further comprising the at least one late-binding system, wherein the at least one late-binding system is adapted to:
stream video content to an associated client device in response to a request for the video content;
detect an upcoming ad slot in the video content;
select one of the plurality of advertisement categories for the ad slot;
determine whether the one of the advertisement categories selected for the ad slot is assigned to the advertisement cache;
obtain the advertisement for the one of the plurality of advertisement categories selected for the ad slot from the advertisement cache if the one of the plurality of advertisement categories selected for the ad slot is assigned to the advertisement cache;
obtain the advertisement for the one of the plurality of advertisement categories selected for the ad slot from the ad content server if the one of the plurality of advertisement categories selected for the ad slot is not assigned to the advertisement cache; and
insert the advertisement into the ad slot as the video content is streamed to the associated client device.

8. The system of claim 7 wherein:
the ad content server comprises a high-speed storage device adapted to store the advertisements for the plurality of advertisement categories, wherein a range of addresses in the high-speed storage device is allocated to each of the plurality of advertisement categories; and
in order to obtain the advertisement from the ad content server, the at least one late-binding system is further adapted to initiate an RDMA transfer of the advertisement from the range of addresses in the high-speed storage device allocated to the one of the plurality of advertisement categories selected for the ad slot to an ad buffer of the at least one late-binding system.

9. The system of claim 7 wherein a range of addresses in the advertisement cache is allocated to each of the at least one of the plurality of advertisement categories assigned to the advertisement cache and, in order to obtain the advertisement from the ad content server, the at least one late-binding system is further adapted to initiate an RDMA transfer of the advertisement from the range of addresses in the advertisement cache allocated to the one of the plurality of advertisement categories selected for the ad slot to an ad buffer of the at least one late-binding system.

10. The system of claim 9 wherein the at least one late-binding system is communicatively coupled to the advertisement cache via a Local Area Network (LAN).

11. A system comprising:
a) a communication interface; and
b) a control system associated with the communication interface and hosting a cache assignment agent adapted to:
i) assign at least one of a plurality of advertisement categories to an advertisement cache communicatively coupled to an a content server storing an advertisement for each of the plurality of advertisement categories, the advertisement cache associated with at least one late-binding system adapted to perform late-binding of advertisements to video content; and
ii) effect transfer of the advertisement for the at least one of the plurality of advertisement categories from the ad content server to the advertisement cache, wherein the at least one late-binding system subsequently obtains the advertisement from the advertisement cache for use in a late-binding operation.

12. The system of claim 11 wherein the ad content server comprises:
a high-speed storage device adapted to store the advertisement for each of the plurality of advertisement categories; and
a Remote Direct Memory Access (RDMA) interface associated with the high-speed storage device;
wherein in order to effect transfer of the advertisement for the at least one of the plurality of advertisement categories from the ad content server to the advertisement cache, the cache assignment agent is further adapted to initiate an RDMA transfer of the advertisement for the at least one of the plurality of advertisement categories from the high-speed storage device to the advertisement cache via the RDMA interface.

13. The system of claim 11 wherein the cache assignment agent is further adapted to assign the at least one of the plurality of advertisement categories to the advertisement cache based on at least one of a group consisting of: historical use and expected use.

14. The system of claim 11 wherein the cache assignment agent is further adapted to:
receive a signature for the at least one late-binding system from a local agent associated with the at least one late-binding system; and
assign the at least one of the plurality of advertisement categories to the advertisement cache based on the signature.

15. The system of claim 14 wherein the signature includes information indicative of at least one of a group consisting of: at least one of the plurality of advertisement categories previously used by the at least one late-binding system for a late-binding operation, at least one of the plurality of advertisement categories expected to be used by the at least one late-binding system, at least one advertisement previously skipped by a viewer at a client device served by the at least one late-binding system, at least one of the plurality of advertisement categories for which an advertisement was previously skipped by a viewer of a client device served by the at least one late-binding system, at least one advertisement previously viewed by a viewer at a client device served by the at least one late-binding system, at least one of the plurality of advertisement categories for which an advertisement was previously viewed by a viewer at a client device served by the at least one late-binding system, and profiles of viewers associated with client devices served by the at least one late-binding system.

16. A method of caching advertisements in a late-binding architecture including an ad content server storing an advertisement for each of a plurality of advertisement categories, at least one late-binding system connected to the ad content server via a network and operating to perform late-binding of advertisements to video content, and an advertisement cache associated with the at least one late-binding system, comprising:
assigning at least one of the plurality of advertisement categories to the advertisement cache; and
effecting transfer of the advertisement for the at least one of the plurality of advertisement categories from the ad content server to the advertisement cache, wherein the at least one late-binding system subsequently obtains the advertisement from the advertisement cache for use in a late-binding operation.

17. The method of claim 16 wherein effecting transfer of the advertisement for the at least one of the plurality of advertisement categories from the ad content server to the advertisement cache comprises initiating a Remote Direct Memory Access (RDMA) transfer of the advertisement for the at least one of the plurality of advertisement categories from a range of addresses in a high-speed storage device of the ad content server allocated to the at least one of the plurality of advertisement categories to the advertisement cache.

18. The method of claim 16 wherein assigning the at least one of the plurality of advertisement categories to the advertisement cache comprises assigning the at least one of the plurality of advertisement categories to the advertisement cache based on at least one of a group consisting of: historical use and expected use.

19. The method of claim 16 wherein assigning the at least one of the plurality of advertisement categories to the advertisement cache comprises assigning the at least one of the plurality of advertisement categories to the advertisement cache based on a signature of the at least one late-binding system received from a local agent associated with the at least one late-binding system.

20. The method of claim 19 wherein the signature includes information indicative of at least one of a group consisting of: at least one of the plurality of advertisement categories previously used by the at least one late-binding system for a late-binding operation, at least one of the plurality of advertisement categories expected to be used by the at least one late-binding system, at least one advertisement previously skipped by a viewer at a client device served by the at least one late-binding system, at least one of the plurality of advertisement categories for which an advertisement was previously skipped by a viewer of a client device served by the at least one late-binding system, at least one advertisement previously viewed by a viewer at a client device served by the at least one late-binding system, at least one of the plurality of advertisement categories for which an advertisement was previously viewed by a viewer at a client device served by the at least one late-binding system, and profiles of viewers associated with client devices served by the at least one late-binding system.

21. The method of claim 16 further comprising:
streaming video content from the at least one late-binding system to an associated client device in response to a request for the video content;
detecting an upcoming ad slot in the video content;
selecting one of the plurality of advertisement categories for the ad slot;
determining whether the one of the advertisement categories selected for the ad slot is assigned to the advertisement cache;
obtaining the advertisement for the one of the plurality of advertisement categories selected for the ad slot from the advertisement cache if the one of the plurality of advertisement categories selected for the ad slot is assigned to the advertisement cache;
obtaining the advertisement for the one of the plurality of advertisement categories selected for the ad slot from the ad content server if the one of the plurality of advertisement categories selected for the ad slot is not assigned to the advertisement cache; and
inserting the advertisement into the ad slot as the video content is streamed to the associated client device.

22. The method of claim 21 wherein streaming the video content comprises streaming the video content via one of a group consisting of: a Switched Digital Video (SDV) channel and an Internet Protocol Television (IPTV) channel.

23. The method of claim 21 wherein the ad content server comprises a high-speed storage device adapted to store the advertisements for the plurality of advertisement categories and a range of addresses in the high-speed storage device is allocated to each of the plurality of advertisement categories, and obtaining the advertisement from the ad content server comprises initiating an RDMA transfer of the advertisement from the range of addresses in the high-speed storage device allocated to the one of the plurality of advertisement categories selected for the ad slot to an ad buffer of the at least one late-binding system.

24. The method of claim 21 wherein a range of addresses in the advertisement cache is allocated to each of the at least one of the plurality of advertisement categories assigned to the advertisement cache, and obtaining the advertisement from the ad content server comprises initiating an RDMA transfer of the advertisement from the range of addresses in the advertisement cache allocated to the one of the plurality of advertisement categories selected for the ad slot to an ad buffer of the at least one late-binding system.

25. The method of claim 24 wherein the at least one late-binding system is communicatively coupled to the advertisement cache via a Local Area Network (LAN).
